(19) United States
(12) Patent Application Publication
(10) Pub. No.: US 2009/0052885 A1
(43) Pub. Date: Feb. 26, 2009

(54) Carriage having a running direction adjustment device for performing circular travels, in particular for film or video shots

(76) Inventor: Sebastian Cramer, Munchen (DE)

Correspondence Address: ROTHWELL, FIGG, ERNST & MANBECK, P.C., 1425 K STREET, N.W., SUITE 800, WASHINGTON, DC, 20005, US

(21) Appl. No.: 12/222,974

(22) Filed: Aug. 21, 2008

(30) Foreign Application Priority Data
Aug. 22, 2007 (DE) 102007039611.4

(51) Int. Cl. G03B 17/00; A47K 1/04

(52) U.S. Cl. 396/428; 248/129

(57) ABSTRACT

A carriage, in particular a camera carriage, includes at least three running rollers (3a, 3b, 4) arranged at an angular distance about a vertical axis and each rotatable about a horizontal running roller axle (5a, 5b, 5c), wherein the running roller axles (5a, 5b) of at least two running rollers (3a, 3b) are aligned with a common rotational axis (A) and the running roller axle (5c) of at least one further adjustable running roller (4) is turnable in a horizontal plane. There is provided a running direction adjustment device (8, 9, 9a, 11, 12, 14, 15, 18, 21) for indirectly or directly indicating and/or determining and/or adjusting the distance (r) of a reference point (10) at the carriage (1) to an intersection point (S), which is dependent on the turning position of the further running roller (4), between the common rotational axis (A) and the rotational axis (B) aligned with the running roller axle (5c) of the adjustable running roller (4).

### CROSS-REFERENCE TO RELATED APPLICATION(S)

This application claims the benefit of German Patent Application No. 102007039611.4, filed Aug. 22, 2007, the disclosure of which is incorporated herein in its entirety by reference.

### FIELD OF APPLICATION AND PRIOR ART

The invention relates to a carriage having a running roller adjustment device for indicating, determining and/or adjusting the distance to the rotational center during circular travel movements.

DE 103 297 47 discloses a swivel head system, in particular for film and video cameras, wherein at least three running rollers are mounted in a flat holding element, which running rollers can be individually aligned and fastened in their running directions, and wherein marks or scales are provided for adjusting the running direction. These scales or adjustment devices can be utilized to align the axles of all the running rollers such that their imaginary extensions intersect in one point. Thus, when displacing the unit, a circular travel movement is performed about this very point.

Herein, it must be taken care, when aligning the running rollers for circular travel movements, that the turning positions of the running directions of the individual running rollers are very accurately coordinated. This is the only way to guarantee that the extensions of the individual axles meet precisely in one point. The respective running directions to be adjusted at the scales can be determined by means of tables or small calculating programs for the individual wheels. Herein, it is disadvantageous that such an adjustment operation is quite complicated and that the distance to the rotational center cannot be read off at the unit itself any more. For a cameraman it is, however, very helpful, when adjusting such a circular movement, to have an exact idea of the precise radius, for example, in order to be able to keep an object during a circular movement at the center of the image. A further disadvantage may arise when not all of the wheels are aligned in a coordinated manner since in this case a travel cannot be executed neatly anymore.

WO 99/51911 discloses a camera carriage having four pairs of running rollers, wherein two pairs of running rollers can be fixed such that their axles are aligned with each other and wherein the running directions of the two other running rollers can be adjusted by means of a steering device such that the extensions of their axles respectively meet in one point on the line of the axles which are rigidly aligned with each other. This is achieved by means of a complex steering mechanism, which renders such a system quite costly and moreover has a considerable size. Here, too, the cameraman does not have any information about the radius or the diameter of such an adjusted circular travel.

### SUMMARY OF THE INVENTION

It is the object of the present invention to provide a carriage using a simple construction wherein the radius or the diameter of a circular travel can be indicated or predetermined as desired in a simple manner.

This object is achieved by a carriage, in particular a camera carriage, comprising at least three running rollers arranged at an angular distance about a vertical axis, each of said running rollers being rotatable about a horizontal running roller axle, wherein running roller axles of at least two of said running rollers are aligned with a common rotational axis and a running roller axle of at least one further adjustable running roller is turnable in a horizontal plane, wherein a running direction adjustment device for indirectly or directly indicating and/or determining and/or adjusting a distance of a reference point at said carriage to an intersection point, which is dependent on a turning position of said adjustable running roller, between said common rotational axis and a rotational axis aligned with said running roller axle of said adjustable running roller.

The advantages obtained by the invention are in particular that a cameraman is given an exact idea of the radius or the diameter of a circular travel and that he is thus enabled to directly coordinate the composition of an image with the camera movement. The distance between the rotational center and a reference point on the carriage can be directly or indirectly read off or determined.

Thus, a number of camera applications can be performed in a faster and less complicated manner, for example, when the cameraman wants to keep an object at the center of the image during a circular travel.

Preferably said running direction adjustment device comprises a scale which indirectly or directly indicates said distance at a read-off mark.

In further preferred embodiment said scale has a metric scale range and/or an imperial scale range which allows the representation of metric as well as imperial distances.

In a further embodiment said running direction adjustment device comprises a digital display which indirectly or directly indicates said distance numerically, for example metrically and/or imperially.

Preferably a separate display is provided which indicates parallel positioning of all said running roller axles for a parallel alignment of all the running rollers whereby linear travels become possible.

Said running direction adjustment device advantageously comprises an actuator drive which adjusts said at least one adjustable running roller in order to obtain a predetermined distance.

In another preferred embodiment of the invention said running direction adjustment device comprises a direction-finding device which is constructed and can be arranged such that a first direction finding is located in a vertical plane of said common rotational axis and defines a point at a predetermined distance to said reference point and a second direction finding is located in a vertical plane extending through said rotational axis of the adjustable running roller, wherein said adjustable running roller can be turned such that said second direction finding of said direction-finding device likewise points to said intersection point.

This enables the alignment of the running roller turnable in a horizontal plane, so that the camera carriage performs a circular travel with a defined radius.

Said direction-finding device preferably comprises a laser direction-finding element or a direction-finding element which can be swiveled in a respective vertical plane.

In a further preferred embodiment of the invention said running direction adjustment device including said adjustable running roller is mounted detachably at a holding element. This enables the detachment of the running direction adjustment device together with the running roller and the bearing from the carriage in order to insert other running roller modules, such as running rollers which automatically align in the travel direction and thus enable controllable steering movements.

Advantageously at least one of said running rollers is formed by a double roller which preferably comprises two roller elements arranged at a distance apart and inclined with respect to each other, the two roller elements having center axles intersecting in a common vertical plane, wherein an upper distance of said center axles is smaller than a lower distance. Such double rollers are especially suitable to be used together with rail profiles.

Hereinafter the invention is explained in greater detail by means of the drawings, wherein

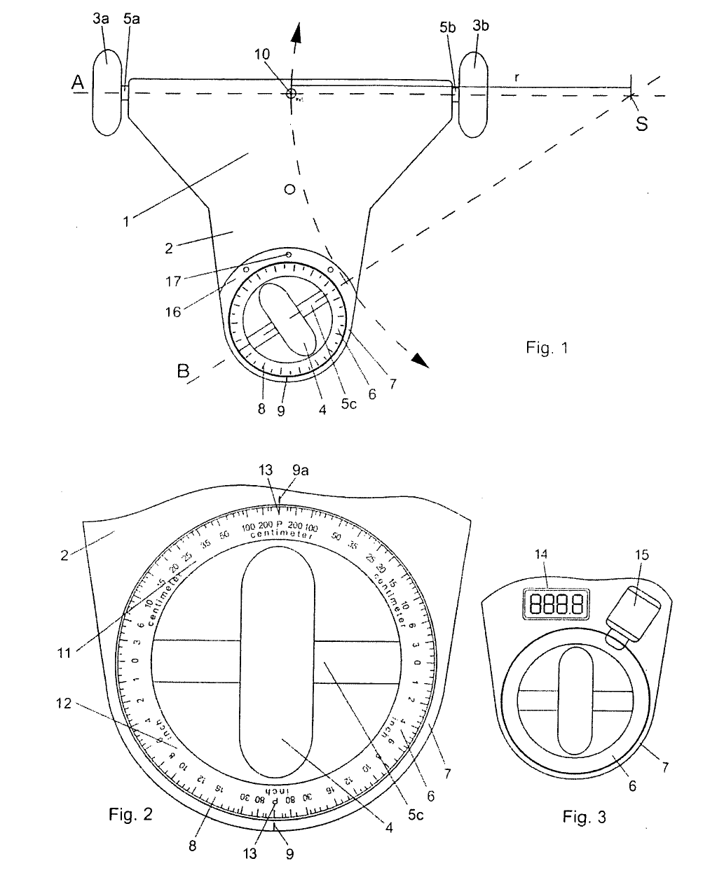

FIG. 1 is a plan view of a carriage together with a schematic representation of a circular travel;

FIG. 2 is a detailed plan view of a running roller and its mounting in a bearing element, wherein the running roller is provided with a metric and an imperial scale;

FIG. 3 is a plan view of a running roller and its mounting in a bearing element, wherein the running roller is provided with a digital display and an actuator motor;

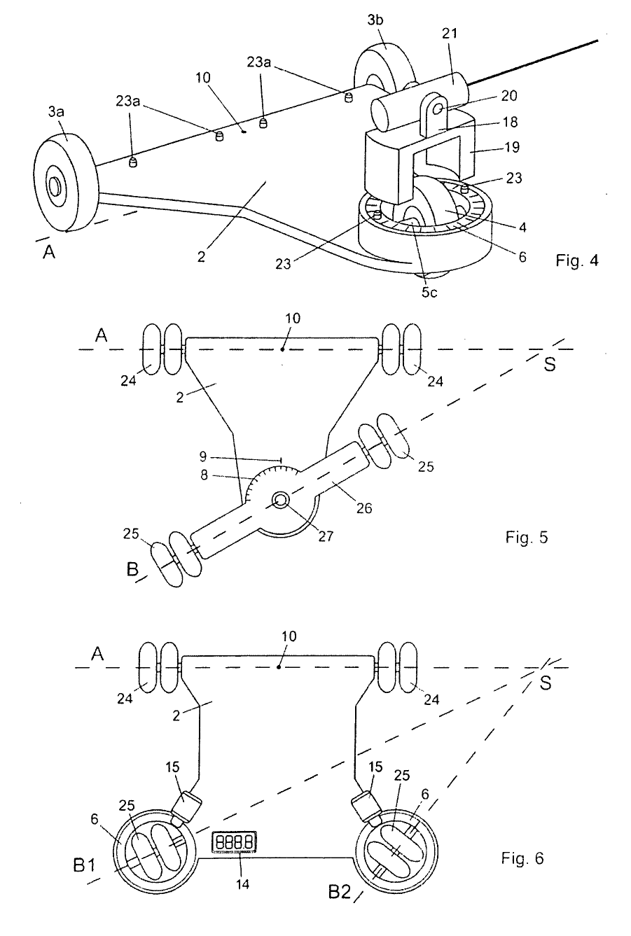

FIG. 4 is a diagrammatic representation of a carriage having a laser direction-finding element which can be slipped onto register pins;

FIG. 5 is a schematic representation of a carriage having two double rollers mounted at a turnable elongate bearing element;

FIG. 6 is a schematic representation of a carriage having two double rollers, each of which can be turned by means of actuator drives;

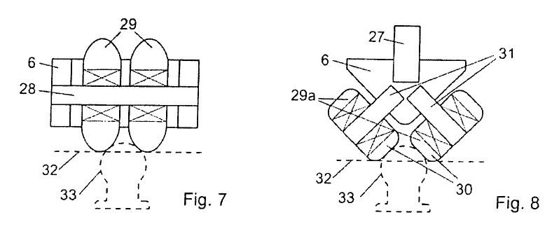

FIG. 7 is a sectional view of a double roller having two running rollers which are parallel with respect to each other;

FIG. 8 is a sectional view of a double roller having two roller elements which are inclined with respect to each other.

### DETAILED DESCRIPTION

In accordance with FIG. 1, the carriage of the present invention has a flat holding element 2 lying on three running rollers 3a, 3b, 4, which are arranged at an angular distance about an imaginary vertical axis going through the holding element 2. Such a holding element 2 is suitable for carrying camera swivel heads, which are either mounted directly on the upper surface of the holding element or are fixed at an elevated position by means of columns, stands, lifting devices or the like. Neither the camera swivel heads nor their mountings will be explained here in more detail.

The running rollers 3a, 3b, 4 each rotate about a horizontal running roller axle 5a, 5b, 5c, wherein two running rollers 3a and 3b are arranged such that their running roller axles 5a, 5b are aligned with each other and form a common rotational axis A. Herein, it is possible that the running rollers 3a and 3b are rigidly mounted as well as that they can be aligned and fixed by means of a device which is not further shown, such as a bearing turnable in a horizontal plane.

A further running roller 4 is mounted with its running roller axle 5c in a bearing element 6 turnable in a horizontal plane. Advantageous is a running roller arrangement wherein the running roller 4 forms the apex of an isosceles triangle and the running rollers 3a and 3b form the base, since thereby an even weight distribution and a symmetrical running behavior is obtained when the running roller 4 is turned. In an ideal case the running rollers are arranged in an equilateral triangle.

In order to achieve a flat construction, the bearing element 6 is advantageously supported such that it can be turned in a bearing ring element 7 which is arranged at the outer surface of the holding element 2 and is connected thereto or formed integrally therewith. Of course, other arrangements of such a running roller 4 turnable in a horizontal plane are conceivable, too, for example, by mounting the running roller 4 in a horizontally turnable fork-shaped axle mount below the holding element 2.

There is provided a brake, but not shown in the drawing, by means of which the horizontal turning of the bearing element 6 can be locked with respect to the bearing ring element 7. Alternative solutions instead of a brake would be to design the turning to be so sluggish that any unintended misadjustment of the running direction can be excluded, or to use, for example, self-inhibiting gears, such as worm gears or actuator drives for alignment.

If the running direction of the running roller 4 is turned in such a manner that its running roller axle 5c is not parallel to the common rotational axis A, a rotational axis B aligned with the running roller axle 5c intersects with the common rotational axis A in one point which during shifting of the carriage forms the rotational center S of a circular travel. In order to determine the distance between the rotational center S and the carriage 1, a reference point 10 is provided on the upper surface of the holding element 2 above the common rotational axis A. The distance between the rotational center S and the reference point 10 forms the adjustable radius r of such a circular travel.

Advantageously such a reference point 10 is provided in the middle between the two running rollers 3a, 3b, especially if the running rollers are arranged in an isosceles triangle in which the running roller 4 forms the apex, since in this way a symmetrical running behavior which is dependent on the turning position of the running roller 4 is obtained on both sides of the carriage. It is also conceivable that the reference point 10 on the carriage is not actually visible, but that it is an imaginary reference point.

For a targeted alignment of the running roller 4, the exemplary embodiment shown here provides, as a running direction adjustment device, a scale 8 mounted on the upper surface of the bearing element 6 and enabling the radius r resulting from a respective turning position between the rotational center S and the reference point 10 to be read off opposite a read-off mark 9 on the bearing ring element 7. It goes without saying that such a scale can be used for the alignment of a circular travel with a predetermined radius r as well as for the determination of a circular travel for an existing adjustment. Likewise, of course, the scale 8 could be mounted on the bearing ring element 7 and the read-off mark could be provided on the bearing element 6.

If during a circular travel, for example, a certain object is to remain at the center of the image, it is only necessary to align the carriage 1 such that the common rotational axis A points to the object, then to determine the distance between the object and the reference point 10 and to adjust the determined value at the scale 8 opposite the read-off mark 9. From then on, the object is at the rotational center of the circular travel.

It is advantageous and known for such a carriage 1 to provide a brake, not further shown, which prevents undesired travel and can, for example, be achieved by blocking one or a plurality of running rollers 3a, 3b, 4. Alternatively, for example, a brake element can be extended from the bottom side of the holding element 2, which brake element gets into contact with the stand-on surface.

An advantageous further embodiment can be obtained by connecting the bearing ring element 7 and the holding element 2 detachably by means of a fastening device 16. In the simplest case such a connection can be achieved by means of simple fastening screws 17 and optional fitting pins, not further shown. Connections by means of groove and tongue or other fittings or suspension devices are also conceivable.

An advantage of such a running direction adjustment device which can be detached together with the running roller 4 and the bearings 6, 7 is that other running roller modules can be fastened to the holding element 2, which are, for example, equipped with running rollers which automatically align in the travel direction, thereby enabling steering movements of the camera carriage.

FIG. 2 shows a detailed view of a scale 8 already explained above on a bearing element 6 having the features of the description of FIG. 1.

In this exemplary embodiment, the scale 8 has a circular portion of 180° width with a metric scale range 11 and a circular portion of 180° width with an imperial scale range 12, which are opposite each other and are each delimited by the running roller axle 5c. The respective radius r which would be performed during a circular travel is indicated by means of marks and numbers opposite a read-off mark 9. The unit is defined by the inscription “centimeter” or “inch”. Moreover, the metric and the imperial scale ranges 11, 12 are clearly distinguishable from each other.

In addition to a metric and an imperial representation of the radius r, further indirect or direct displays of the distance between the rotational center S and the reference point 10 are conceivable. Of course, other measuring units, such as millimeter instead of centimeter can be used. Likewise, the diameter of a circular travel could be indicated instead of the radius. It would also be conceivable to use, for example, values from 1 to 10, alphabetical sequences of letters or names, or marks corresponding to defined distances between the rotational center S and the reference point 10.

In addition to the read-off mark 9 already explained above, this exemplary embodiment has a further read-off mark 9a arranged on the opposite side on the bearing ring element 7. This makes it possible to simultaneously work with metric and imperial radii.

The scale 8 has two further separate marks 13, which in the embodiment shown are provided with the letter “P” and which indicate that the running roller axle 5a of the running roller 4 is aligned in parallel to the common rotational axis A. Thus, all the running rollers 3a, 3b and 4 have the same alignment and the carriage 1 performs a linear travel movement.

FIG. 3 shows an alternative embodiment of a running roller adjustment device of the running roller 4 turnable in a horizontal plane. In this case a digital display 14 is provided for indicating the radius r or the diameter of a circular travel. Advantageously such a display is provided with the possibility of a metric and an imperial representation, which can be changed, for example, by means of a switch. Likewise a simultaneous display of both values is conceivable.

The turning of the bearing element 6 in the bearing ring element 7 can, for example, be determined by means of an incremental transducer, preferably by means of an absolute incremental transducer, not further shown in FIG. 3. By means of a simple trigonometric function the turning angle is represented on the digital display 14 as a numerical value or other indirect or direct representations of the radius r of a circular travel.

It is also conceivable to achieve the horizontal turning of the running roller axle 5c by means of an actuator drive 15, such as a servo or step motor which aligns the running direction in such a manner that a predetermined radius r or diameter of a circular travel is achieved. Such an embodiment is, of course, also conceivable with a digital display 14.

FIG. 4 shows a carriage with a further alternative embodiment of a running roller adjustment device in the form of a direction-finding device 18 for adjusting a predetermined radius r of a circular travel.

The direction-finding device 18 shown here comprises a laser direction-finding element 21, wherein the beam of the laser direction-finding element 21 is advantageously supported such that it can be swiveled in a vertical plane extending through the running roller axle 5c of the adjustable running roller 4. Instead of a laser direction-finding element, for example, an aiming telescope, a notch and bead, or other optical direction-finding elements are conceivable. It would also be conceivable to incorporate such a direction-finding element directly into the running roller axle 5c.

It is likewise advantageous that such a direction-finding device 18 is detachably connected to the bearing element 6. In the exemplary embodiment shown, a mount 19 for a direction-finding element has guide bores at its bottom side which engage in appropriately designed register pins 23 at the upper side of the bearing element 6. Of course, other positive-locking connections between the direction-finding device 18 and the bearing element 6 are also conceivable. Likewise a fixed connection could be provided. Due to the fact that the construction of the mount 19 for the direction-finding element is open at its bottom side, such a direction-finding device 18 can accommodate the upper portion of a running roller 4.

Further register pins 23 are mounted on the holding element 2 on the common rotational axis A, which enable the direction-finding device 18 to be slipped thereon in such a manner that the beam of the laser direction-finding element 21 can be swiveled in a vertical plane extending through the common rotational axis A. The direction-finding device 18 shown can be slipped onto the bearing element 6 as well as onto the common rotational axis A. Alternatively, it is imaginable to incorporate a direction-finding element directly into the common rotational axis A.

In order to adjust a circular travel with a predetermined radius r, the direction-finding device 18 which is slipped onto the holding element 2 is used to determine a point S on the common rotational axis A with a predetermined horizontal distance to the reference point 10. By slipping the direction-finding device 18 onto the bearing element 6, it can then be turned in a horizontal plane such that the beam of the laser direction-finding element 21 likewise points to the common intersection point S.

Of course, such a direction-finding device 18 can not only be used for determining the rotational distance r, but also for positioning an object for an already adjusted circular travel. For this, the direction-finding device 18 is alternately slipped onto the holding element 2 on the common rotational axis A and onto the bearing element 6, wherein the object is displaced such that in both cases the beam of the laser direction-finding element 21 points to the object.

FIG. 5 shows the embodiment of a carriage with two running rollers formed as double rollers 24, the axles of which are aligned with a common rotational axis A, and with two further double rollers 25, each of which is mounted at an end of a longitudinally extending bearing element 26, which is supported at its center such that it can be turned about a vertical axle 27. The turning position can be locked by means of a brake not shown, but already explained.

Such double rollers are frequently used for camera carriages lying on a rail profile having a round shape at its upper side. Due to the double rollers shown here, such a carriage can be used on a rail profile, for example, for linear travels, as well as on a running surface for additional circular travels.

The rotational axles of the two double rollers 25 are aligned with the adjustable rotational axis B and intersect in one point S. The distance between the reference point 10 and the intersection point S can be indirectly or directly read off on a scale 8 opposite the read-off mark 9.

FIG. 6 shows the embodiment of a carriage having similar features as in FIG. 5, wherein in this case two double rollers 25, each of which is mounted in a bearing element 6, are aligned each by means of an actuator drive 15 such that the imaginary extensions of their running roller axles B1 and B2 meet in an intersection point S. The distance r between the reference point 10 and the intersection point S can be indirectly or directly read off at a digital display 14. Likewise it is possible to align the double rollers 25 for achieving a circular travel with a predetermined radius r.

Instead of the actuator drives, such a running roller adjustment device can also comprise a mechanical steering, as known from WO 00/51911, which is coupled with a corresponding display for representing the distance r. Likewise, scales can be provided on the bearing elements 6, enabling an adjustment of the distance r at each of the two double rollers 25 individually.

FIG. 7 shows a sectional view of a double roller 29 consisting of two running rollers arranged in parallel to each other and supported such that they can be turned about a common axle 28. Herein, the common running roller axle 28 is mounted in a bearing element 6. As already mentioned, such a double roller can be used on a flat stand-on surface as well as on a rail profile having a round shape towards its upper side.

FIG. 8 shows a sectional view of a double roller 29a having two roller elements 30 arranged at a distance apart and inclined with respect to each other, the center axles 31 of which intersect in a common vertical plane, wherein the upper distance of the center axles 31 is smaller than the lower distance. The double roller 29a is supported in a bearing element 6 such that it can be turned about a vertical axle 27. This arrangement, too, is suitable for using the double roller 29a likewise on a flat stand-on surface 32 as well as on a rail profile 33 having a round shape towards its upper side. In this case, the rotational axis of the double roller 29a is to be understood as a horizontal axis extending through the centers of the roller elements 30.

What is claimed is:

1. A carriage, in particular a camera carriage, comprising at least three running rollers arranged at an angular distance about a vertical axis, each of said running rollers being rotatable about a horizontal running roller axle, wherein running roller axles of at least two of said running rollers are aligned with a common rotational axis and a running roller axle of at least one further adjustable running roller is turnable in a horizontal plane, wherein a running direction adjustment device for indirectly or directly at least one of indicating, determining or adjusting a distance of a reference point at said carriage to an intersection point, which is dependent on a turning position of said adjustable running roller, between said common rotational axis and a rotational axis aligned with said running roller axle of said adjustable running roller.

2. The carriage in accordance with claim 1, wherein said running direction adjustment device comprises a scale which indirectly or directly indicates said distance at a read-off mark.

3. The carriage in accordance with claim 2, wherein said scale has at least one of a metric scale range or an imperial scale range.

4. The carriage in accordance with claim 1, wherein said running direction adjustment device comprises a digital display which indirectly or directly indicates said distance numerically.

5. The carriage in accordance with claim 4, wherein said digital display indirectly or directly indicates said distance metrically at least one of imperially.

6. The carriage in accordance with claim 1, wherein a separate display is provided which indicates parallel positioning of all said running roller axles.

7. The carriage in accordance with claim 1, wherein said running direction adjustment device comprises an actuator drive which adjusts said at least one adjustable running roller in order to obtain a predetermined distance.

8. The carriage in accordance with claim 1, wherein said running direction adjustment device comprises a direction-finding device which is constructed and can be arranged such that a first direction finding is located in a vertical plane of said common rotational axis and defines a point at a predetermined distance to said reference point and a second direction finding is located in a vertical plane extending through said rotational axis of said adjustable running roller, wherein said adjustable running roller can be turned such that said second direction finding of said direction-finding device likewise points to said intersection point.

9. The carriage in accordance with claim 8, wherein said direction-finding device comprises a laser direction-finding element.

10. The carriage in accordance with claim 8, wherein said direction-finding device comprises a direction-finding element which can be swiveled in a respective vertical plane.

11. The carriage in accordance with claim 1, wherein said running direction adjustment device including said adjustable running roller is mounted detachably at a holding element.

12. The carriage in accordance with claim 1, wherein at least one of said running rollers is formed by a double roller.

13. The carriage in accordance with claim 12, wherein said double roller comprises two roller elements arranged at a distance apart and inclined with respect to each other, the two roller elements having center axles intersecting in a common vertical plane, wherein an upper distance of said center axles is smaller than a lower distance.
